(19) United States
(12) Patent Application Publication
(10) Pub. No.: US 2023/0245520 A1
(43) Pub. Date: Aug. 3, 2023

(54) MODULAR PERSONALIZED STORAGE LOCKER

(71) Applicant: Turlough O'DONNELL, Dublin (IE)

(72) Inventor: Turlough O'DONNELL, Dublin (IE)

(21) Appl. No.: 18/001,527

(22) PCT Filed: Jun. 3, 2021
(86) PCT No.: PCT/EP2021/064927

§ 371 Date: Dec. 12, 2022

(30) Foreign Application Priority Data
Jun. 10, 2020 (GB) 2008770.6
May 11, 2021 (GB) 2106706.1

(51) Int. Cl. G07F 17/12; A47B 61/00; E05B 47/00

(52) U.S. Cl. CPC G07F 17/12; A47B 61/003; E05B 47/0001

(57) ABSTRACT

A storage locker system of the invention (1) made up of a carcass (2) and portable self-contained locker bags (3) insertable on demand in and removable on demand from open locker bag bays 4 defined in the carcass (2), the carcass (2) being positionable as desired in any required location such as an educational or sports facility while the locker bags (3) can be purchased (or hired) by a user for exclusively personal use and be re-used repeatedly with the carcass (2).

### INTRODUCTION

This invention relates to a modular personalized storage locker system suitable for storing various articles ranging from personal items such as clothing, sports equipment and other personal items to laundry, groceries and the like.

### BACKGROUND OF THE INVENTION

Storage locker systems are widely used in sports facilities, educational facilities, public transport hubs and the like to temporarily store personal items, clothing, sports equipment, luggage, shopping and the like.

Generally, known storage locker systems are made up of large cabinets which are subdivided into self-contained separate walled compartments or lockers in which personal items such as bags and the like can be stored. Accordingly, each self-contained locker is essentially a box provided with a lockable access door which can be opened by a user with a key or coded access mechanism. Users can be provided with the key or access code on a permanent or temporary basis such as in educational or sports facilities or can purchase a key or access code to hire a specific locker on a temporary ad-hoc basis such as in public transport hubs.

However, known walled box-like storage lockers suffer from a number of disadvantages. For example, where lockers are used by multiple users on a temporary basis, the lockers, and in particular the walls of the lockers, can become dirty or unhygienic thus requiring cleaning which can increase maintenance costs. Being walled, users may also inadvertently come upon detritus or litter left by previous users in the lockers which can prove to be an unpleasant experience. As the individual lockers are contained, such detritus can give rise to strong contaminating odours in the lockers which can be difficult or impossible for an unsuspecting user to remove before use. In addition, as a user is unable to identify a dirty, contaminated or unusable locker before accessing the locker, the user may have already paid for access to a locker before discovering that the locker requires cleaning or, in extreme cases, is unusable. In addition, due to pandemic concerns, it is now necessary in many countries for lockers to be decontaminated between use. This is labour intensive and costly, and can limit the use of lockers.

Large walled locker systems can also be the subject of vandalism and graffiti, and when placed outdoors, can be susceptible to adverse weather conditions, and become damaged by wind and rain. This can lead to expensive maintenance costs.

Furthermore, where large walled locker systems having large numbers of individual lockers are deployed, such as in educational establishments, it can be difficult for a user to immediately identify those lockers which are available for use let alone usable once accessed.

An object of the invention is to overcome at least some of the problems of the prior art.

### SUMMARY OF THE INVENTION

According to the invention there is provided a storage locker system comprising:
a carcass;
a plurality of walless locker bag bays in the carcass defined by rails;
at least one portable locker bag complementary with the locker bag bays, and
a releasable locking mechanism for locking the locker bag in the locker bag bays.

Preferably, each locker bag bay comprises an open front. More preferably, the locker bag bays also comprise an open rear. Most preferably, the locker bag bays comprise open sides.

Suitably, the locker bag bays are box-shaped locker bag bays.

In one embodiment, the box-shaped locker bag bays are rectangular in cross-section.

Optionally, the bays are of various sizes to accommodate different sized portable locker bags.

Suitably, a locking mechanism is provided at each locker bag bay.

In any embodiment, the locking mechanism comprises a front locking mechanism on the carcass at the open front of the locker bag bay.

In one embodiment, the front locking mechanism comprises a front locking bar at the front of each locker bag bay movable between a locked position in which a locker bag is locked in a locker bag bay and an unlocked position in which a locker bag is removable from the locker bag bay or a locker bag is insertable in the locker bag bay. Preferably, the locking bar is swingable between the locked and unlocked positions.

In another embodiment, the front locking mechanism comprises a panel slidable between a locked position in which a locker bag is locked in a locker bag bay and an unlocked position in which a locker bag is removable from the locker bag bay or a locker bag is insertable in the locker bag bay. Suitably, the slidable panel comprises a clear or Perspex slidable panel.

In any embodiment, the locking mechanism comprises a rear locking mechanism on the carcass at the open rear of the locker bag bay.

Suitably, the rear locking mechanism is operable between the carcass and the locker bag.

Optionally, the rear locking mechanism comprises a latch locking mechanism.

Preferably, the latch locking mechanism comprises a latch on the carcass at each locker bag bay and a complementary latch bar on each locker bag, the latch being movable between a locked position in which the latch engages the latch bar on the locker bag and an unlocked position in which the latch is disengaged from the latch bar.

Advantageously, the latch bar is located in a recess in the locker bag.

In any embodiment, the locker bag comprises an internal reinforcing frame disposed around the periphery of the locker bag.

Advantageously, the storage locker system further comprises a control panel on the carcass for controlling access to the storage locker system.

Preferably, the storage locker system further comprises a payment point to pay for use of the storage locker system. Preferably, the payment point is communicable with an online account that the user has subscribed to for charging purposes. Alternatively or in addition, the payment point comprises a cash and/or card payment point.

In a preferred embodiment of the invention, the carcass comprises a mobile carcass. Preferably, the carcass is mounted on a platform provided with a wheelset. Optionally, the wheels of the wheelset are lockable into mooring stations for security.

In any embodiment of the invention, the system is internet enabled.

In a preferred embodiment of the invention, the locker bag can be purchased for personal use by a user. In one embodiment of the invention, the locker bag is assigned a unique identifier code. Alternatively or in addition, the locker bag is assigned a PIN code.

In a particularly preferred embodiment of the invention the storage locker system comprises a sports, education, entertainment or transport facility storage locker system.

The invention also extends to a locker bag configured for use with a storage locker system of the invention as hereinbefore defined.

Suitably, the locker bag comprises a container portion for storing items and an openable and closable front and/or top panel attached to the container portion. Preferably, the container portion comprises shoulder straps and/or side belts for carrying the locker bag.

Advantageously, the locker bag can be purchased for personal use by a user.

Suitably, the locker bag is assigned a unique identifier barcode or PIN code.

The storage locker system of the invention is suitable for storing various articles ranging from personal items such as clothing, sports equipment and other personal items to laundry, groceries and the like. Accordingly, it is not intended that the invention be limited to a storage locker system for a particular item so that the storage locker of the invention is considered to have a wide range of commercial applications. For example, the locker system of the invention can be employed for the delivery and collection of laundry and similar items where a laundry company collects and delivers laundry using the locker bags of the locker system of the invention.

The advantages of the invention are many. Unlike a typical locker system, the bays of the storage locker system of the invention are walless i.e. have no floor, ceiling, or walls but are defined only by the rails of the system. Accordingly, the locker box bays and complementary personalized, portable and self-contained locker bags obviate the cleanliness and/or odour problems encountered with conventional locker systems in which users must use what is effectively a shared locker space. As a result, a user does not encounter detritus or odours from previous locker users. In addition, the open nature of the walless carcass of the locker system of the invention ensures aeration and freshness of the locker system. Additionally, there is no requirement to clean and sterilize the lockers between use. Due to the open nature of the locker system, there is reduced opportunity for graffiti or vandalism. For similar reasons, there is a significantly reduced likelihood of weather damage taking place.

The locker bags and locker bag bays of the system of the invention can also be sized as required.

As users can purchase portable locker bags for personal use, users can utilise the locker bags at multiple locker system locations. Moreover, the portable locker bags can effectively function as a bag for carrying items if desired—particularly if the locker bag is shaped and styled appropriately.

### BRIEF DESCRIPTION OF THE DRAWINGS

The invention will now be described, by way of example only, with reference to the accompanying drawings in which:

FIG. 1 is a front elevation of a mobile carcass of a storage locker system of the invention subdivided into open individual locker bag bays with the locking mechanisms removed for clarity and each locker bag bay being configured to receive a removable, portable and personal locker bag in each locker bag bay and with two locker bags being inserted in the carcass;

FIG. 2 is an enlarged front plan view of an individual locker bag bay with the peripheral envelope-like locking mechanism in the open bag bay receiving position;

FIG. 3 is a front elevation of the individual locker bag bay of FIG. 2 with a locker bag inserted in the locker bag bay and the surrounding locking mechanism in the locked position to secure the locker bag in the locker bag bay;

FIG. 4 is a rear plan view of the locker bag of FIGS. 1 to 3 with the rear shoulder straps and adjustable side belts visible on the locker bag;

FIG. 5 is a perspective view from above and one side of a second embodiment of the invention showing the internal vertical and horizontal rails defining the locker bag bays of the storage locker system in which the system is also provided with a front locking mechanism in the form of a front locking bar and a rear latch-like locking mechanism for securely preventing unwanted removal of a locker bag from a locker bag bay;

FIG. 6 is a slightly modified front elevation of the storage locker system of FIG. 5 in which the carcass is provided with locker bag bays of varying sizes to receive variously sized locker bags;

FIG. 7 is a top plan view of the top side a locker bag of the system of FIG. 5 showing the internal metal rim or frame and peripheral access zip of the locker bag;

FIG. 8 is a bottom plan view of the underside of the locker bag of FIG. 7 showing the locking bar for the latch-like locking mechanism on the locker bag;

FIG. 9 is a rear plan view of the locker bag of FIG. 8;

FIG. 10 is a side elevation of the locker bag of FIG. 8 with the latch of the rear latch-like locking mechanism engaged with the rear locking bar on the locker bag;

FIG. 11 is a side elevation of the locker bag with the latch of the rear latch-like locking mechanism disengaged from the rear locking bar on the locker bag, and

FIG. 12 is a schematic representation of the storage locker system of FIGS. 5 to 11.

### DETAILED DESCRIPTION OF THE INVENTION

As shown in the drawings, a storage locker system of the invention is generally indicated by the reference numeral 1 and is made up of a carcass 2 and portable self-contained locker bags 3 insertable on demand in and removable on demand from open locker bag bays 4 defined in the carcass 2. The carcass 2 can be positioned as desired in any required location such as an educational or sports facility while the locker bags 3 can be purchased (or hired) by a user for exclusively personal use and be re-used repeatedly with the carcass 2.

The carcass 2 is made up of a bottom wall 5, a first outer sidewall 6, an oppositely disposed second outer sidewall 7 and a top wall 8. The carcass 2 has no rear or front wall so that the carcass 2 is open to the front and rear. As indicated above, internally the carcass 2 is subdivided into walless locker bag bays 4, which extend front to rear in the carcass 2, by spaced apart inner vertical rails 9 which extend vertically between the bottom wall 5 and the top wall 8, and spaced apart horizontal rails 10 which extend horizontally between the first and second outer sidewalls 6, 7 respectively. The inner vertical rails 9 and the inner horizontal rails 10 intersect to define the locker box bays 4. In other words, there are no floors, walls or ceilings in the locker bag bays 4 formed by the rails 9,10. A number of the locker bag bays 4 that are disposed at the bottom wall 5, sidewalls 6,7 or top wall 8 of the carcass 2 may have one wall defined by the bottom wall 5, sidewalls 6,7 or top wall 8 however all locker bag bays are walless on at least three sides with the majority of the internal locker bag bays (i.e. those not located at the bottom wall 5, sidewalls 6,7 or top wall 8) are completely wallless. As a result there is open communication between the locker bag bays 4.

As the carcass 2 is open to the front and rear, the locker bag bays 4 are each therefore provided with an open front 11 and an open rear 12. The locker bag bays 4 are shaped and sized to receive the locker bags 3 through the open front 11.

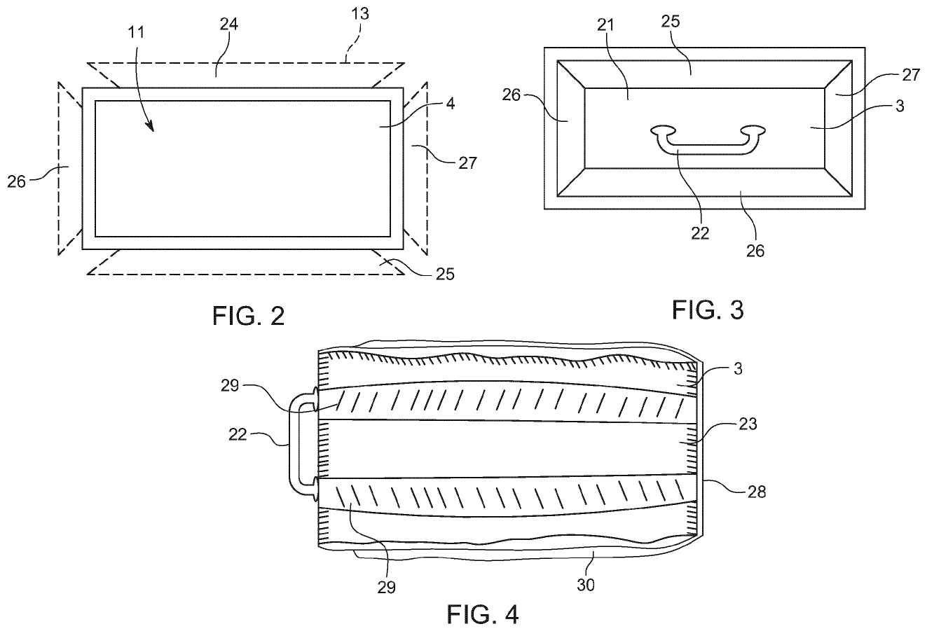

Each locker bag bay 4 is provided with a locking mechanism 13 so that a locker bag 3 can be securely locked in a locker bag bay 4. In one embodiment, the locking mechanism 13 can be key activated while in an alternative embodiment the locking mechanism 13 can be code activated. The locking mechanism 13 can be any suitable locking mechanism 13 such as a mechanical, electronic or electrical locking mechanism. However, in the present embodiment, the locking mechanism 13 is a peripheral envelope-like locking mechanism formed at the open front 11 of each locker box bay 4. More particularly, the peripheral locking mechanism 13 is formed at the sidewalls 6,7 and the inner vertical and horizontal rails 9,10 of the carcass 2 defining the open front 11 of the locker box bays 4. As shown particularly in FIG. 2, the peripheral locking mechanism 13 is envelope-like in construction and is made up of hinged peripheral flaps at the open fronts 11 configured to move between an open locker bag 3 receiving position and a locked locker bag 3 secured position in which the size of the open front 11 of the locker box bay 4 is reduced to prevent removal of the locker bag 3 from the locker box bay 4 i.e. a hinged upper flap 24, an oppositely disposed hinged lower flap 25, a first side flap 26 and an oppositely disposed second side flap 27.

Operation of the locking mechanism 13 can be controlled via one or more control panels 14 provided on the carcass 2. The control panel 14 is provided with a display screen 15, a cash payment point 16 and a credit/debit card payment point 17. Where the locking mechanism 13 for each locker box bay 4 is code activated, the control panel 14 is adapted to display or release an access code to a user in response to payment so that the user can securely lock their personal locker bag in a locker bag bay 4. Where the locking mechanism 13 is key activated, the control panel 14 can be configured to release a key for a locker bag bay 4 in response to payment. However, it is envisaged that access code controlled locking mechanisms 13 would be a user preference. The locking mechanism 13 can also be an automatic locking mechanism 13 that locks automatically upon insertion of a locker bag 3 in a locker bag bay 4.

In alternative embodiments of the invention, the locking mechanism 13 can be provided on the locker bag 3 but can be controlled via the control panel 14. The locking mechanism 13 can also be provided on the locker bag 3 and at the locker bag bay 4 if desired.

If desired, the carcass 2 is further provided with a signage panel on the top wall 8.

In the present embodiment, the bottom wall 5 of the carcass 2 can be formed by a (reinforced) platform 19 which supports the carcass 2. The platform 19 is provided with a wheelset 20 to render the carcass 2 and hence the locker system 1 of the invention mobile so that the locker system 1 of the invention can be positioned in any desired location.

As shown particularly in FIGS. 3 and 4, the bag 3 is dimensioned and shaped to be received in a locker box bay 4 and has a rectangular front panel 21 fitted with a handle 22 for lifting the locker bag 3 and positioning the locker bag 3 in a locker bag bay 4. The locker bag 3 is provided with a container portion 23 which is attached to and extends rearwardly from the front panel 21 and terminates at a secure rear panel 28. The front panel 21 can be removably or hingedly attached to the container portion 23 to facilitate access to the container portion 23. Alternatively, the container portion 23 can be provided with an alternate access point to the container portion 23. The container portion 23 is further provided with a pair of shoulder straps 29 for carrying the locker bag 3 and, optionally, adjustable side belts 30. The locker bag 3, and in particular the container portion 23 of the locker bag 3 can be inserted in a locker bag bay 4 by gripping the handle 22 and sliding the container portion 23 into a locker bag bay 4. The locker bag 3 can then be secured in the locker bag bay 4 by activating the locking mechanism 13.

If desired, in some embodiments, the container portion 23 can be modified in accordance with the items to be carried in the locker bag 3 e.g. the locker bag 3 can be refrigerated if desired.

In use, the carcass 2 of the locker system 1 is positioned in a location such as an educational, sports, or commercial facility as required. The carcass 2 can be moved within and to a location on the wheelset 20 if desired. Users wishing to use the locker system 1 can purchase a locker bag 3 from a designated supplier such as a supermarket or the like if desired. The user can then retain the locker bag 3 for repeated personal re-use so that the user is responsible for the maintenance of their own locker bag 3. In essence, the locker bag 3 replaces what one would currently think of as a locker.

When the user wishes to store items in the locker system 1, the user then simply makes the appropriate payment either online (preferred method) or receives an access code (or key) as previously described and slides the locker bag 3 containing the items into a designated locker bag slot 4. The user then activates the locking mechanism 13 to lock the locker bag 3 in the locker bag slot 4—or the locking mechanism 13 can be activated automatically upon insertion of the locker bag 3 in the locker bag slot 4.

As the user is employing a personal, portable locker bag 3, problems surrounding the use of communal conventional lockers are avoided—i.e. users do not encounter previous locker users' detritus and the like. Users can therefore enjoy the use of a clean locker system 1. Moreover, maintenance of the locker system is reduced as items are not left by users in the locker system. As empty locker bag bays 4 are immediately visible to a user, the user can immediately identify which locker bag bays 4 are available for use—unlike conventional lockers where it can be difficult to locate an available locker.

In order to retrieve the locker bag 3, the user can simply key in a pin identification number (PIN) code in the case of online account holders, or an access code provided to those who pay with cash or card at the display screen 15 to release the locking mechanism 13.

In another embodiment of the invention, the system can be internet enabled only so that users can be required to set up an online account, and will be administered a unique (e.g. 5-digit PIN), which will be linked to a unique identifier code e.g. a barcode of their purchased personal locker bag 3. Payment can be made through the online account and it is envisaged that most payments would be made via the online account. Upon arrival at the carcass 2, the user selects a free bay 4 which is numbered. The user then presses a “select locker bag bay number” option from the control panel 14 and then scans the unique barcode, present on the locker bag 3, against the control panel 14.

The user then enters the unique 5-digit PIN on the control panel 14 and places the locker bag 3 in the selected locker box bay 4.

From the time of entering the PIN, there can be a suitable period, e.g. a 20-second period during which the user can place the locker bag 3 in the selected locker bag bay 4. After the 20-second period, the locking mechanism 13 will secure the locker bag 3 in the locker bag bay 4.

To remove the portable locker bag 3 from the carcass 2, the user can enter the locker bag bay 4 number and the 5-digit PIN to release the locking mechanism 13 and the portable locker bag 3.

If desired, a user's account can be charged based on usage.

As will be appreciated by those skilled in the art, the carcass 2 can be sized as required while the locker box bays 4 and complementary locker bags 3 can be numbered and sized as required e.g. the locker system 1 can be adapted as required for the storage of items of various sizes in locker box bays 4 and locker bags 3 of varying sizes. The locker box bays 4 and associated locker bags 3 can also be shaped as desired i.e. the locker box bays 4 and locker bags 3 need not be box-like or rectangular in shape e.g. cylindrical locker box bays 4 and complementary cylindrical locker bags 3 could be employed if desired.

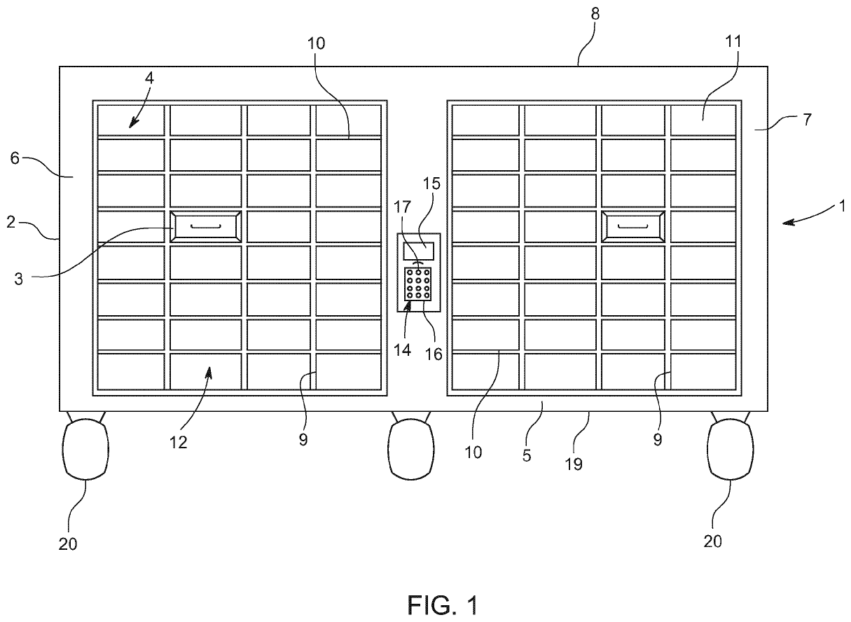

In addition, while the locker box bays 4 in the carcass 2 of the locker system 1 shown in FIGS. 1 and 2 have an open front 11 and an open rear 12 so that the locker box bays 4 are see-through locker box bays 4, in an alternative embodiment the carcass 2 can be provided with a rear wall so that each locker box bay 4 has an open front 11 only.

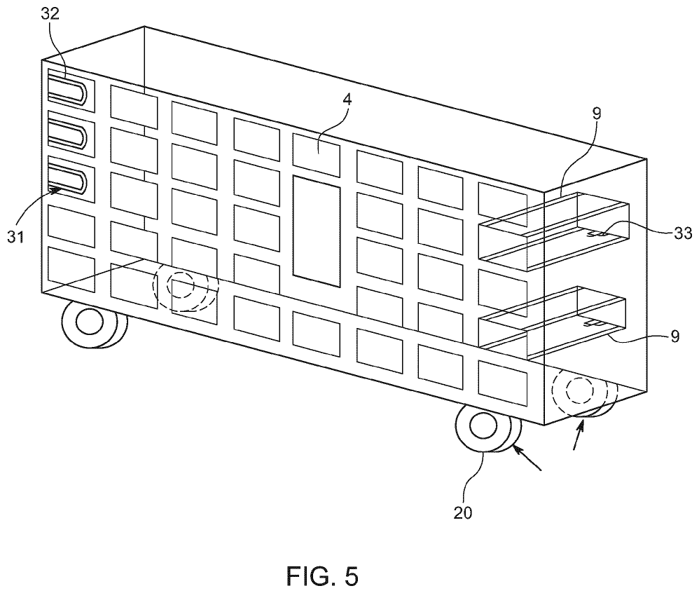

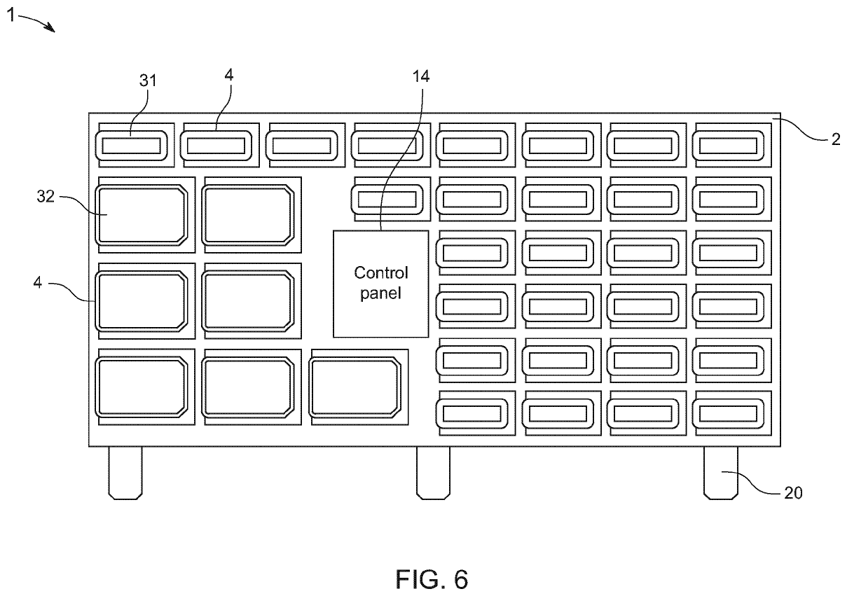

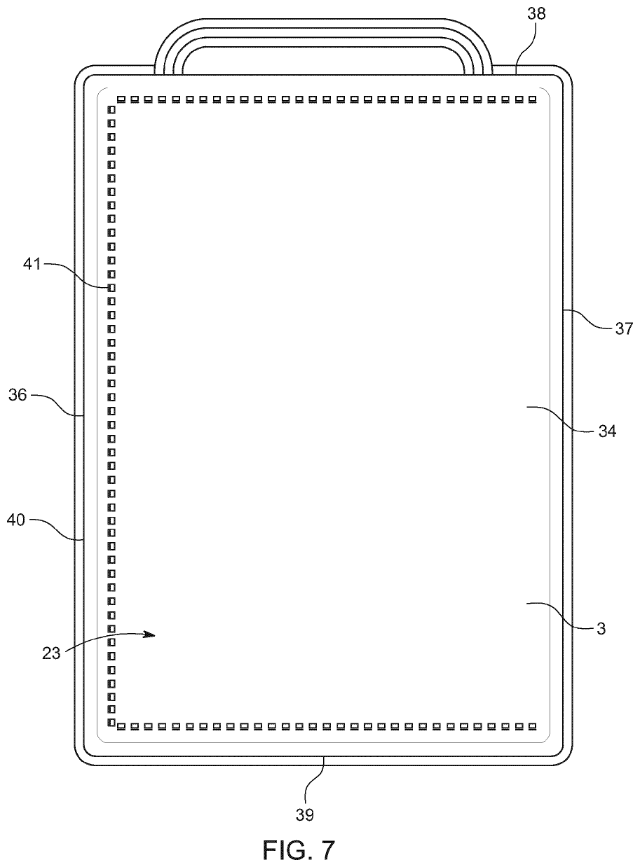

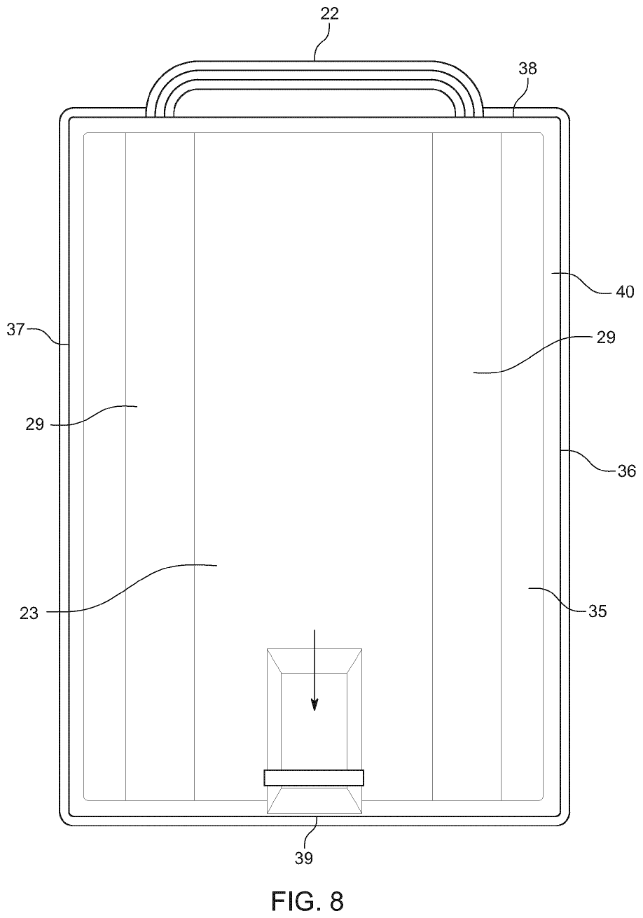

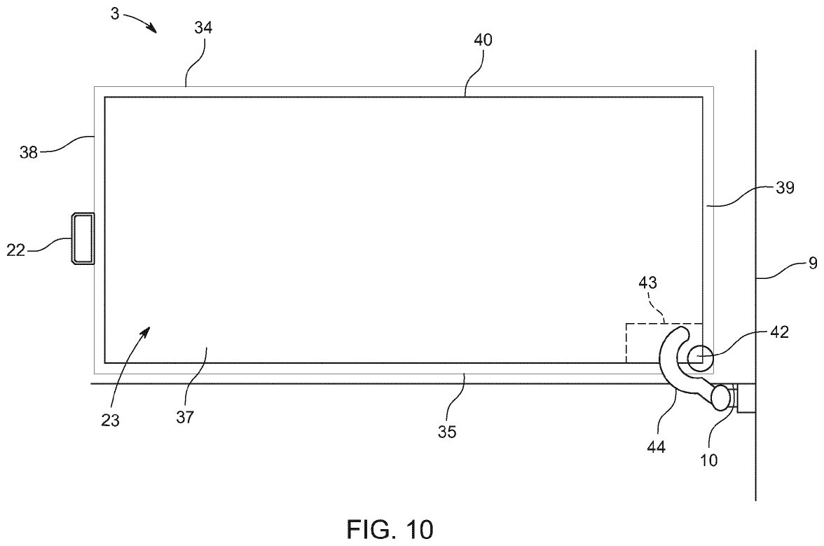

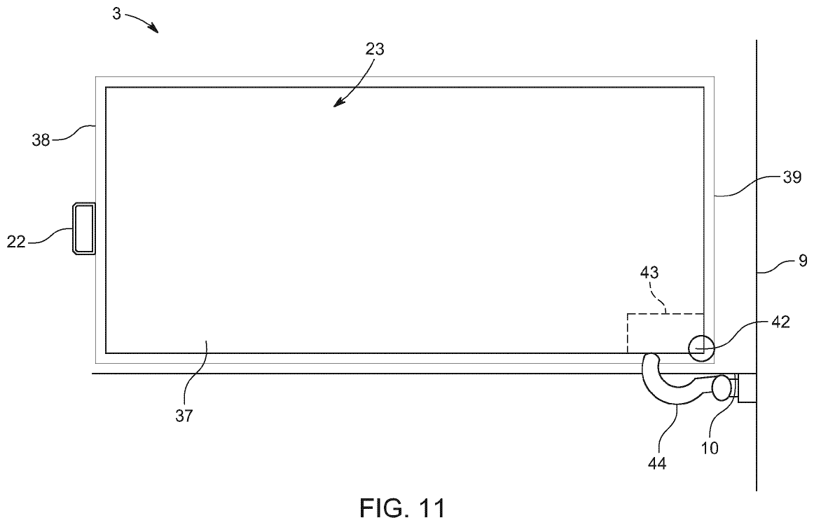

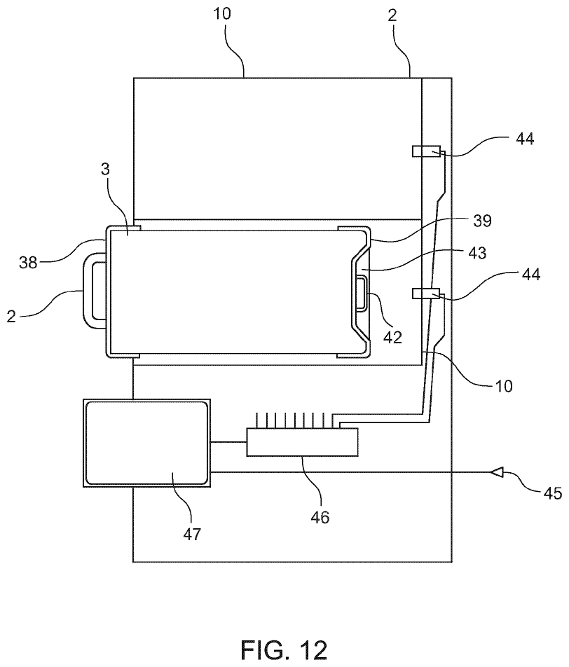

FIGS. 5 to 12 show another embodiment of the invention similar to the system described in FIGS. 1 to 4 and like numerals indicate like parts. However, in the present embodiment, each locker bay is provided with an openable/closable locking mechanism 13 in the form of a carcass front locking mechanism 31 at each locker bag bay 4 to prevent unwanted removal of locker bags 3 from the locker bag bays 4. In the present embodiment, the carcass front locking mechanism 31 is a carcass front locking bar 32 mounted at the front of each locker bag bay 4 which is movable between a locked position in which a locker bag 3 is locked in a locker bag bay 4 and an unlocked position in which a locker bag 3 is removable from the locker bag bay 4 or a locker bag 3 is insertable in the locker bag bay 4. When a locker bag bay 4 is not in use, the carcass front locking mechanism 31 can remain in the locked position to prevent unwanted access to locker bags 3 in adjacent locker bag bays 4. As shown in FIGS. 5 and 6, the carcass front locking bar 32 can a have a suitable shape to prevent access to a locker bag bay such as a horseshoe shape shown in FIG. 5 or a square frame shape shown in FIG. 6. Generally, the front locking bar 32 is shaped and configured to enable full visualisation of the carcass 2 and locker bags 3 within the carcass 2.

In the present embodiment, the carcass front locking bar 32 is swingably mounted at each locker bag bay 4 to enable movement between the locked and unlocked positions.

In another embodiment, the carcass front locking mechanism 31 can be made up of a see-through panel slidable between a locked position in which a locker bag 3 is locked in a locker bag bay 4 and an unlocked position in which a locker bag 3 is removable from the locker bag bay 4 or a locker bag is insertable in the locker bag bay. For example, the see-through slidable panel can be made up of a clear or Perspex slidable panel.

The carcass front locking mechanism 31 can be electrically activated to open allowing insertion of a locker bag 3 in a locker bag bay 4, and then automatically close upon insertion of a locker bag 3 to aid in security.

In the present embodiment, the system is also provided with a rear latch-like locking mechanism 33 operable between the locker bag 3 and the carcass 2 for further securely preventing unwanted removal of a locker bag 3 from a locker bag bay 4. This is described in more detail below.

The locker bag 3 of the present embodiment is typically formed of a vulcanised rubber or similar material to provide a locker bag 3 having a generally rectangular shape in cross-section so that the locker bag has a topside 34, an oppositely disposed bottom side 35, first and second sidewalls 36,37, a front wall 38 and a rear wall 39 which can be formed from a hard material such as a hard plastics material. The locker bag 3 is reinforced by an internal reinforcing frame 40 disposed around the periphery of the locker bag 3. The reinforcing frame 40 can be a strong material such as metal to provide structure to the locker bag 3 and also to prevent access to the contents of the locker bag 3 contained within the container portion 23 of the locker bag 3. The topside 34 of the locker bag 3 can also be provided with a peripheral zip 41 to access the contents.

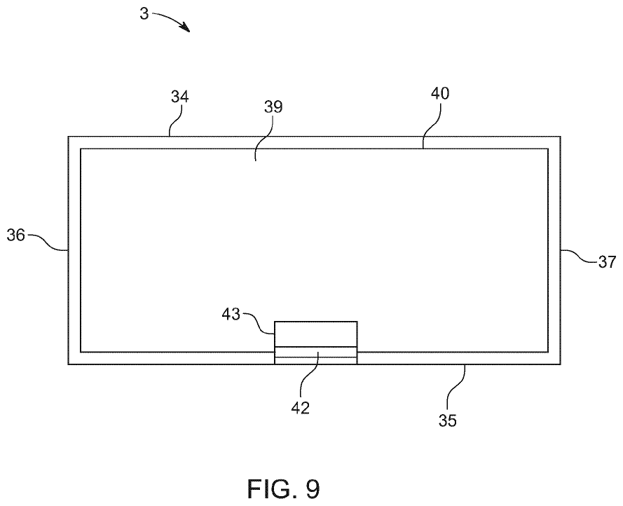

As indicated above and as shown particularly in FIGS. 9 to 12, the locker system of the present embodiment is provided with a rear latch-like locking mechanism 33 operable between the locker bag 3 and the carcass 2. More particularly, the rear latch-like locking mechanism 33 is made up of a latch locking bar 42 which is typically an exposed portion of the locker bag reinforcing frame 40 located in a generally centrally positioned recess 43 defined in the rear wall 39 and bottom wall 35 of the locker bag 3. At each locker bag bay 4, the carcass 2 is provided with a complementary latch 44 engageable with the latch locking bar 42. The complementary latch 44 is mounted on the horizontal rails 10 of the carcass 2 and is movable between a locked position in which the latch engages the latch locking bar 42 on the locker bag and an unlocked position in which the latch is disengaged from the latch locking bar 42.

In use, upon activation and insertion of a locker bag into a locker bag bay 4, the latch 44 (which can be selectively electrically actuated e.g. by a mains supply 45, distributor 46 and console 48 in communication with the control panel 14/display 15) engages with the latch locking bar 44 thus locking the locker bag 3 in the locker bag slot 4.

In one embodiment, the locking mechanism 13, including either the carcass front locking mechanism 31 or the rear locking mechanism 33 or both, can be key activated while in an alternative embodiment the locking mechanism 13 can be code activated. The specific form of locking mechanisms 13 employed can be any suitable locking mechanisms 13 such as mechanical, electronic or electrical locking mechanisms.

Operation of the locking mechanisms 13 can be controlled via the control panel 14 provided on the cabinet 2. For users with an online account, presentation of the unique locker bag bar identifier code to the control panel 14 will initiate the control panel 14 to prompt the user to select an unused locker bag bay 4. The user will then have a defined period of time (e.g. 30 seconds) to place the locker bag 3 into the available locker bag bay 4 chosen. Once the rear locking mechanism 33 has engaged with the locker bag 3, the carcass front locking mechanism 31 will then close automatically. Users can then be charged based on time usage.

1. A storage locker system comprising:
a carcass;
a plurality of walless locker bag bays in the carcass defined by rails;
at least one portable locker bag complementary with the locker bag bays, and
a releasable locking mechanism for locking the locker bag in the locker bag bays.

2. A storage locker system as claimed in claim 1 wherein the locker bag bays comprises an open front.

3. A storage locker system as claimed in claim 1 or claim 2 wherein the locker bag bays comprise an open rear.

4. A storage locker system as claimed in any of claims 1 to 3 wherein the locker bag bays comprise open sides.

5. A storage locker system as claimed in any of claims 1 to 4 wherein the locker bag bays are box-shaped locker bag bays.

6. A storage locker system as claimed in any of claims 1 to 5 wherein the box-shaped locker bag bays are rectangular in cross-section.

7. A storage locker system as claimed in any of claims 1 to 6 wherein the locker bag bays are of various sizes to accommodate different sized portable locker bags.

8. A storage locker system as claimed in any of claims 3 to 7 wherein a locking mechanism is provided at each locker bag bay.

9. A storage locker system as claimed in claim 8 wherein the locking mechanism comprises a front locking mechanism on the carcass at the open front of the locker bag bay.

10. A storage locker system as claimed in claim 9 wherein the front locking mechanism comprises a front locking bar at the front of each locker bag bay movable between a locked position in which a locker bag is locked in a locker bag bay and an unlocked position in which a locker bag is removable from the locker bag bay or a locker bag is insertable in the locker bag bay.

11. A storage locker system as claimed in claim 10 wherein the locking bar is swingable between the locked and unlocked positions.

12. A storage locker system as claimed in claim 9 wherein the locking mechanism comprises a panel slidable between a locked position in which a locker bag is locked in a locker bag bay and an unlocked position in which a locker bag is removable from the locker bag bay or a locker bag is insertable in the locker bag bay.

12. storage locker system as claimed in claim 12 wherein the slidable panel comprises a clear or Perspex slidable panel.

14. A storage locker system as claimed in any of claims 8 to 13 wherein the locking mechanism comprises a rear locking mechanism on the carcass at the open rear of the locker bag bay.

15. A storage locker system as claimed in claim 14 wherein the rear locking mechanism is operable between the carcass and the locker bag.

16. A storage locker system as claimed in claim 15 wherein the rear locking mechanism comprises a latch locking mechanism.

17. A storage locker system as claimed in claim 16 wherein the latch locking mechanism comprises a latch on the carcass at each locker bag bay and a complementary latch bar on each locker bag, the latch being movable between a locked position in which the latch engages the latch bar on the locker bag and an unlocked position in which the latch is disengaged from the latch bar.

18. A storage locker system as claimed in claim 17 wherein the latch bar is located in a recess in the locker bag.

19. A storage locker system as claimed in any of claims 1 to 18 wherein the locker bag comprises an internal reinforcing frame disposed around the periphery of the locker bag.

20. A storage locker system as claimed in any of claims 1 to 19 wherein the storage locker system further comprises a control panel on the carcass for controlling access to the storage locker system.

21. A storage locker system as claimed in any of claims 1 to 20 wherein the storage locker system further comprises a payment point to pay for use of the zo storage locker system.

22. A storage locker system as claimed in claim 21 wherein the payment point is communicable with an online account that the user has subscribed to for charging purposes.

23. A storage locker system as claimed in claim 21 or claim 22 wherein the payment point comprises a cash and/or card payment point.

24. A storage locker system as claimed in ay of claims 1 to 23 wherein the storage locker system comprises a sports, education, entertainment or transport facility storage locker system.

25. A storage locker system as claimed in any of claims 1 to 24 wherein the system is internet enabled.

26. A locker bag wherein the locker bag is configured for use in a storage locker system as claimed in any of claims 1 to 25.

27. A locker bag as claimed in claim 26 wherein the locker bag comprises a container portion for storing items and an openable and closable front and/or top panel attached to the container portion.

28. A locker bag as claimed in claim 27 wherein the container portion comprises shoulder straps and/or side belts for carrying the locker bag.

29. A locker bag as claimed in claim 28 wherein the locker bag can be purchased for personal use by a user.

30. A locker bag as claimed in any of claims 27 to 29 wherein the locker bag is assigned a unique identifier barcode or PIN code.
